(19) United States
(12) Patent Application Publication
(10) Pub. No.: US 2025/0115044 A1
(43) Pub. Date: Apr. 10, 2025

(54) PRINTING SYSTEM AND PRINTING METHOD

(71) Applicant: Samsung Display Co., Ltd., Yongin-si (KR)

(72) Inventors: Jongkil Han, Yongin-si (KR); Setsu Takeuchi, Yongin-si (KR); Satoshi Tomoeda, Yongin-si (KR); Myungsoo Huh, Yongin-si (KR)

(73) Assignee: Samsung Display Co., Ltd., Yongin-si (KR)

(21) Appl. No.: 18/911,409

(22) Filed: Oct. 10, 2024

(30) Foreign Application Priority Data
Oct. 10, 2023 (KR) 10-2023-0134359

(51) Int. Cl. B41J 2/045; B41J 2/11

(52) U.S. Cl. CPC B41J 2/04588; B41J 2/04535; B41J 2/04581; B41J 2/11

(57) ABSTRACT

A printing system and a printing method, in which precision of a printing process may be enhanced, the printing system may include a controller configured to generate printing data, a user device configured to generate a first control command, generate modulation data based on a user input, and generate a second control command based on the user input, an additional controller configured to receive the printing data and the second control command and generate a driving signal based on the second control command, and including a memory storing waveform information received from the user device, and a printing device configured to perform a printing operation based on the driving signal.

### CROSS-REFERENCE TO RELATED APPLICATIONS

This application claims priority under 35 U.S.C. § 119 from Korean Patent Application No. 10-2023-0134359 filed on Oct. 10, 2023 in the Korean Intellectual Property Office, the entire contents of which are incorporated herein by reference.

### BACKGROUND

### 1. Technical Field

One or more embodiments relate to a printing system and a printing method in which precision of a printing process is enhanced.

### 2. Description of the Related Art

Industrial inkjet printers use not only general dyes, but also metal materials, such as copper, gold, and silver, ceramics, and polymers, as printing solutions. The industrial inkjet printers may be used for industrial graphics, displays, and solar cells, by printing (e.g., directly printing) on various targets, such as substrates, films, fabrics, and displays. In particular, in display fields, processes using inkjet printers may be applied to color filter manufacturing, liquid crystal alignment processes, organic emission layer manufacturing, and quantum dot emission layer manufacturing. A printing system configured to perform an inkjet printing operation includes an inkjet printing head including at least one ink transfer path (or nozzle).

In case that the printing system configured to perform the inkjet printing operation uses a general-purpose inkjet driver, a uniform and unified ejection waveform may be generated. Because the uniform and unified ejection waveform may be used, precision of a printing process may decrease due to a change in viscosity of ink or expansion of a material according to temperature.

### SUMMARY

One or more embodiments include a printing system and a printing method in which precision of a printing process is enhanced.

Additional aspects will be set forth in part in the description which follows and, in part, will be apparent from the description, or may be learned by practice of the presented embodiments of the disclosure.

According to one or more embodiments, a printing system may include a controller configured to generate printing data, a user device configured to generate a first control command, generate modulation data based on a user input, and generate a second control command based on the user input, an additional controller configured to receive the printing data and the second control command and generate a driving signal based on the second control command, and including a memory storing waveform information received from the user device, and a printing device configured to perform a printing operation based on the driving signal.

In case that the second control command is a first signal, the driving signal may be a first driving signal including same information as the printing data.

In case that the second control command is a second signal, the driving signal may be a second driving signal including a piece of waveform information loaded from the memory based on the modulation data from among a plurality of pieces of pre-stored waveform information.

The printing data may include location data about locations where ink may be ejected from the printing device, and volume data about ink volume ejected from each nozzle included in the printing device.

The modulation data may include address information about where a plurality of pieces of waveform information may be stored in the memory.

In case that the second control command is a second signal, the driving signal may be a second driving signal including waveform information assigned to the address information in the memory.

The printing device may include a printing head configured to eject ink, wherein the printing head may include a chamber storing ink, and a spray assembly disposed below the chamber, the spray assembly including an ink transfer path extended to inside of the chamber, and the spray assembly externally ejecting the ink from a bottom surface that has passed through the ink transfer path.

The spray assembly may further include a piezoelectric element layer disposed below the chamber, and a nozzle plate disposed below the piezoelectric element layer and having a bottom surface being the bottom surface of the spray assembly.

The first control command, the second control command, and the modulation data may be implemented as digital signals.

The second control command may be generated based on a user input that may be input to the user device.

The printing system may be an additive printing technology, and the second control command may be derived from a learning algorithm based on a plurality of earlier printing results.

According to one or more embodiments, a printing method may include receiving printing data from a controller, receiving a first control command from a user device, receiving modulation data from the user device and storing the modulation data based on the first control command, receiving a second control command from the user device, generating a driving signal based on the second control command, and transmitting the driving signal to a printing device.

In case that the second control command may not be received for a pre-set time, the driving signal may be a dummy driving signal.

In case that the second control command may be received for a pre-set time and the second control command may be a first signal, the driving signal may be a first driving signal including same information as the printing data.

In case that the second control command may be received for a pre-set time and the second control command may be a second signal, the driving signal may be a second driving signal including a piece of waveform information from among a plurality of pieces of pre-stored waveform information, the piece of waveform information may be loaded from a memory and may be based on the modulation data.

The printing data may include location data about locations where ink may be ejected from the printing device, and volume data about ink volume that may be ejected from each nozzle included in the printing device.

The second driving signal may include a waveform signal obtained by changing the location data and the volume data based on the modulation data.

The first control command, the second control command, and the modulation data may be implemented as digital signals.

The second control command may be generated based on a user input that may be input to the user device.

The second control command may be derived from artificial intelligence based on a plurality of earlier printing results.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 3 are diagrams schematically illustrating a printing system according to an embodiment;

FIG. 4 is a schematic cross-sectional view of an example of a printing head of FIG. 3;

FIG. 5 is a flowchart of processes performed by a controller of FIG. 1;

FIG. 6 is a flowchart of processes performed by an additional controller of FIG. 1;

FIG. 7 is a schematic diagram showing examples of a first control command and a second control command which may be implemented as binary numbers;

FIG. 8 is a schematic diagram showing examples of a first signal, a second signal, and modulation data which may be implemented as binary numbers;

FIG. 9 is a schematic diagram showing a result of performing a printing operation by using a printing system and a printing method according to a comparative example; and

FIG. 10 is a schematic diagram showing a result of performing a printing operation by using a printing system and a printing method according to an embodiment.

### DETAILED DESCRIPTION OF THE EMBODIMENTS

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another.

For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

A printing system according to an embodiment will be described in detail based on the above descriptions.

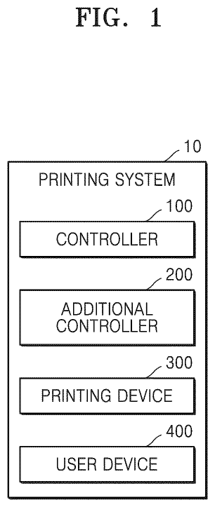

FIGS. 1 to 3 are diagrams schematically illustrating a printing system 10 according to an embodiment.

As shown in FIGS. 1 to 3, the printing system 10 according to an embodiment may include a controller 100, an additional controller 200, and a printing device 300. The printing system 10 according to an embodiment may further include a user device 400.

For reference, the controller 100 and the printing device 300 may be a printing system 10, and the additional controller 200 may be a component added between the controller 100 and the printing device 300. For example, the printing device 300 may perform a printing operation according to printing data from the controller 100 or a separate driving signal generated based on the printing data. Here, locations where ink may be ejected from the printing device 300 and ink volume ejected from each nozzle included in the printing device 300 may be uniform and unified. In case that the additional controller 200 may be added between the controller 100 and the printing device 300, the uniform and unified ink ejection locations and ejected ink volume of each nozzle may be changed by the additional controller 200.

The controller 100 may generate a driving signal for operating the printing operation of the printing device 300 or generate the printing data to be transmitted to the additional controller 200. The controller 100 may include a first transceiver 110, a first storage 120, and a first processor 130. For example, the controller 100 may be implemented as a type of a circuit board. The controller 100 may generate the printing data based on an input image.

The first transceiver 110 may be an input/output interface or network interface of a pre-determined standard. The first transceiver 110 may transmit/receive data to/from the additional controller 200 described below. For example, the first transceiver 110 may transmit/receive data to/from a second transceiver 210 of the additional controller 200 described below. For example, the first transceiver 110 may transmit the printing data to the second transceiver 210 described below, or receive another piece of data from the second transceiver 210. In some cases, the first transceiver 110 may transmit/receive data to/from the user device 400 described below.

The first storage 120 may store data or instructions supporting various functions of the controller 100. For example, the first storage 120 may be a non-volatile memory, and may include at least one type of storage media from among flash memory type, hard disk type, solid state disk (SSD) type, silicon disk drive (SDD) type, multimedia card micro type, and card type memories (e.g., secure digital (SD) and extreme digital (XD) memories), read-only memory (ROM), electrically erasable programmable read-only memory (EEPROM), programmable read-only memory (PROM), magnetic memory, magnetic disk and optical disk. For example, the first storage 120 may include a non-volatile memory and a volatile memory (e.g., random access memory (RAM) or a static random access memory (SRAM)).

The first processor 130 may control other configurations by executing an instruction stored in the first storage 120. The first processor 130 may execute an instruction stored in the first storage 120.

The first processor 130 may perform an operation and control another device. The first processor 130 may indicate a central processing unit (CPU), an application processor (AP), or a graphical processing unit (GPU). The CPU, AP, or GPU may include one or more cores therein, and the CPU, AP, or GPU may operate by using an operating voltage and a clock signal.

The first processor 130 may process a signal, data, or information input or output through components described above, or process an instruction stored in the first storage 120, thereby providing suitable information or function to a user or processing the same.

The printing data may denote data obtained by converting an input image to a pre-set format to drive the printing device 300. For example, the printing data may include location data about locations where ink may be ejected from the printing device 300, and volume data about ink volume ejected from each nozzle included in the printing device 300.

The driving signal may be a signal waveform and may be a signal for instructing the printing operation of the printing device 300. For example, the locations where ink may be ejected from the printing device 300 and/or the ink volume ejected from each nozzle may be determined according to a waveform or frequency of the driving signal.

The additional controller 200 may be electrically connected to the controller 100, and electrically connected to the printing device 300. The additional controller 200 may be added to electrically connect between the controller 100 and the printing device 300. For example, the controller 100 and the printing device 300 may be a printing system, and may be a general-purpose printing system or a generally used printing system. For example, the additional controller 200 may be a configuration for enhancing precision of the printing operation by being added to a general-purpose printing system or a generally used printing system.

The additional controller 200 may include the second transceiver 210, a second storage 220, and a second processor 230. Details about the second transceiver 210 may be the same as those about the first transceiver 110. For example, the second transceiver 210 may be an input/output interface or network interface of a pre-determined standard. For example, the second transceiver 210 may transmit/receive data to/from the controller 100 or the first transceiver 110 described above. The second transceiver 210 may transmit/receive data to/from the user device 400 described below. Details about the second storage 220 may be the same as those about the first storage 120. Details about the second processor 230 may be the same as those about the first processor 130.

For example, the additional controller 200 may receive the printing data from the controller 100, receive a second control command from the user device 400, and include a memory storing waveform information received from the user device 400. Here, the waveform information received from the user device 400 may be waveform information capable of replacing the driving signal generated according to the printing data, and may be information generated by the user device 400 based on data pre-learned through a learning algorithm or the like. In some cases, the received waveform information may be information generated by a setting value input (e.g., directly input) by the user.

For example, the controller 100 and the printing device 300 may exchange data, and the printing device 300 may receive the driving signal from the controller 100 and perform the printing operation according to the received driving signal. The additional controller 200 of the specification may be a configuration that accesses data transmitted from the controller 100 to the printing device 300 and converts or replaces the data transmitted from the controller 100 to the printing device 300 to or with another piece of data. In this regard, the additional controller 200 may be electrically connected to a data wire from the controller 100 to the printing device 300. As a result, the data transmitted from the controller 100 may be converted to another piece of data by the additional controller 200, and the printing device 300 may perform the printing operation according to the driving signal generated based on another piece of data. Here, another data prepared for the conversion may be big data and may be a setting value that may be learned based on numerous printing results or may be input (e.g., directly input) by the user, or data to which the setting value may be applied.

The user device 400 may be a computing device capable of driving an application program, an application, or the like, and may include a user terminal, a computer, or a server. The user device 400 may receive a user input from the user, convert the received user input into a data signal, and transmit the data signal to the additional controller 200 or the second transceiver 210.

The user device 400 may transmit/receive data to/from the additional controller 200 or to/from the second transceiver 210 of the additional controller 200. In some cases, the user device 400 may transmit/receive data to/from the controller 100 or to/from the first transceiver 110 of the controller 100.

For example, the user device 400 may generate a first control command, generate modulation data based on the user input, and generate the second control command based on the user input.

For example, the first control command, the second control command, and the modulation data may be implemented as digital signals (e.g., 0, 1, or a combination of 0 and 1). For example, the second control command may be generated based on the user input that may be input to the user device 400.

Although not illustrated, the user device 400 may be electrically connected to an input part and an output part via wires and/or wirelessly. The input part may include a user interface, such as a key pad, a dome switch, a touch pad (contact capacitance type, pressure resistive type, an infrared detection type, surface ultrasonic wave conduction type, integral tension measuring type, piezo-effect type, or the like), a mouse, a remote controller, a jog wheel, or a jog switch. The output part may include a display. The display may provide a result image output from the user device 400 to enable an operator to monitor a displayed image. The display may provide the operator with visual information and/or auditory information about the printing operation. The display may include a computer screen, a television (TV) screen, a mobile terminal screen, or a projector. In case that the display is a touch screen, the touch screen may also operate as the input part.

The printing device 300 may be a device configured to eject ink at a desired location with desired volume onto a substrate SB described below, and may be a device configured to perform an inkjet printing operation. The printing device 300 may include a third transceiver 310, a driving stage 320, a driving device 330, and a printing head 340. For example, the printing device 300 may perform the printing operation based on the driving signal. For example, the driving signal may include a dummy driving signal, a first driving signal, and a second driving signal.

Details about the third transceiver 310 may be the same as those about the first transceiver 110. For example, the third transceiver 310 may be an input/output interface or network interface of a pre-determined standard. For example, the third transceiver 310 may transmit/receive data to/from the controller 100, the first transceiver 110, the additional controller 200, or the second transceiver 210. Details about a third storage (not shown) may be the same as those about the first storage 120. Details about a third processor (not shown) may be the same as those about the first processor 130.

The substrate SB may be a target on which printing may be performed, and ink may be ejected thereto. The driving stage 320 may be disposed below the substrate SB. For example, the driving stage 320 and the substrate SB may be fixed together, and the substrate SB may move together in case that the driving stage 320 moves. As another example, the driving stage 320 may not move, and only the substrate SB disposed on the driving stage 320 may move. For example, the substrate SB may move on the driving stage 320 according to an air floating technology, and the driving stage 320 may be a component for applying the air floating technology to the substrate SB.

The driving device 330 may move the substrate SB based on a pulse number. For example, the driving device 330 may include a motor configured to move the substrate SB based on the pulse number. For example, the driving device 330 may be an air flow device configured to move the substrate SB based on the pulse number. For example, the driving device 330 may be a configuration for moving the substrate SB by moving the driving stage 320 or for moving only the substrate SB floating on the driving stage 320.

The printing head 340 may denote a head of the printing device 300. The printing head 340 may include at least one nozzle for ejecting an ink material. In case that the printing head 340 includes multiple nozzles, the nozzles may be spaced apart from each other by a certain distance. For example, the printing head 340 may eject ink onto a top surface of the substrate SB according to a cycle obtained based on information about the pulse number.

According to an embodiment, in case that the second control command is a first signal, the driving signal may be a first driving signal including waveform information determined based on the printing data.

According to an embodiment, in case that the second control command is a second signal, the driving signal may be a second driving signal including a piece of waveform information loaded from the memory based on the modulation data from among multiple pieces of pre-stored waveform information.

According to an embodiment, the printing data may include location data about locations where ink may be ejected from the printing device 300, and volume data about ink volume that may be ejected from each nozzle included in the printing device 300.

According to an embodiment, the modulation data may include address information about where multiple pieces of waveform information may be stored in the memory of the additional controller 200. Here, in case that the second control command is a second signal, the driving signal may be a second driving signal including waveform information assigned to the address information in the memory.

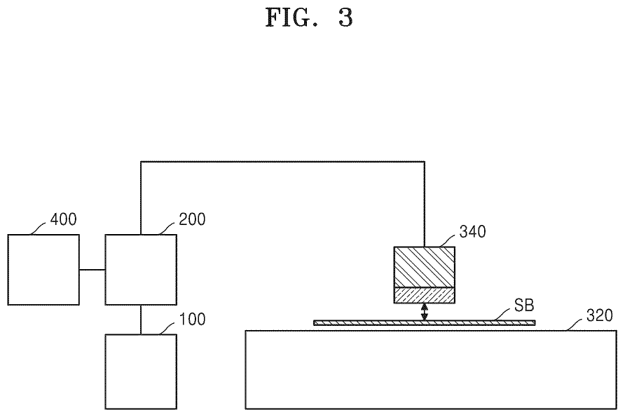

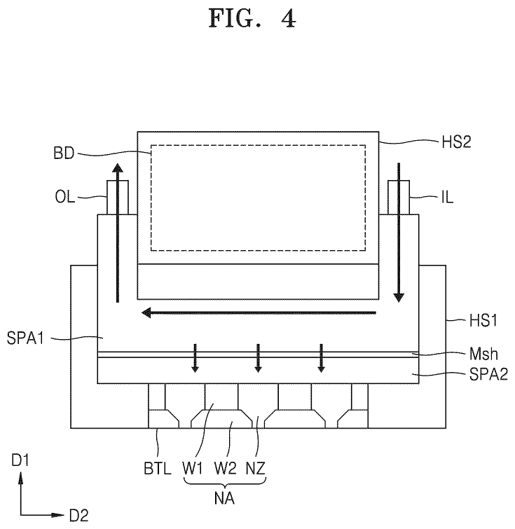

FIG. 4 is a schematic cross-sectional view of an example of the printing head 340 of FIG. 3.

For reference, while describing FIG. 4, details that may be the same as or overlap those of FIG. 3 may be omitted. The printing head 340 of FIG. 3 may be a configuration for printing ink, such as a quantum dot ink composition.

As shown in FIG. 4, the printing head 340 may include first and second chambers SPA1 and SPA2 storing inkjet printing ink, and a spray assembly NA configured to externally eject ink from the first and second chambers SPA and SPA2. The first and second chambers SPA1 and SPA2 and the spray assembly NA may be included inside a first housing HS1 of the printing head 340. The first housing HS1 may extend to a second housing HS2, and a driving circuit BD may be provided inside the second housing HS2. The driving circuit BD may control a piezoelectric element layer W1 described below.

Ink of the printing head 340 may be injected into the first and second chambers SPA1 and SPA2 through an ink inlet IL and externally discharged from the first and second chambers SPA1 and SPA2 through an ink outlet OL. As such, ink may move from the ink inlet IL to the ink outlet OL through the first and second chambers SPA1 and SPA2. The ink inlet IL may penetrate the first housing HS1 to communicate with the first and second chambers SPA1 and SPA2 to inject ink into the first and second chambers SPA1 and SPA2, and the ink outlet OL may penetrate the first housing HS1 to communicate with the first and second chambers SPA1 and SPA2 to discharge ink from the first and second chambers SPA1 and SPA2. The ink inlet IL and the ink outlet OL may be opened or closed as needed, and may be controlled manually or automatically.

The first and second chambers SPA1 and SPA2 for storing ink may include the first chamber SPA1 extended to the ink inlet IL and the ink outlet OL, and the second chamber SPA2 separated from the first chamber SPA1 by a mesh layer Msh.

Ink may be filtered by the mesh layer Msh while moving from the first chamber SPA1 to the second chamber SPA2. Ink that has moved into the second chamber SPA2 may have been filtered, and thus impurities may have been removed therefrom. Ink may be discharged to the outside of the spray assembly NA through an ink transfer path NZ of the spray assembly NA.

The spray assembly NA may externally discharge ink through a bottom surface BTL. The bottom surface BTL of the spray assembly NA may be penetrated by the ink transfer path NZ. The ink transfer path NZ may be a nozzle and may be controlled to externally discharge a suitable amount of ink.

In other words, the spray assembly NA may be disposed below the first and second chambers SPA1 and SPA2, include the ink transfer path NZ extended to the inside of the first and second chambers SPA1 and SPA2, and externally discharge ink that has passed the ink transfer path NZ through the bottom surface BTL.

The spray assembly NA may include the piezoelectric element layer W1 and a nozzle plate W2 disposed below the piezoelectric element layer W1. The piezoelectric element layer W1 may include a piezoelectric material, for example, lead zirconate titanate (PZT). The piezoelectric element layer W1 may be controlled according to an electric signal transmitted from the driving circuit BD, and include a configuration of a piezoelectric actuator. The nozzle plate W2 may include an organic material such as polyimide (PI), or include a metal material such as stainless steel (SUS), iron (Fe), chromium (Cr), nickel (Ni), or a combination thereof.

The spray assembly NA may include the ink transfer path NZ penetrating the piezoelectric element layer W1 and the nozzle plate W2. The ink transfer path NZ may have a bottleneck structure. Accordingly, ink discharged through the ink transfer path NZ may have higher hydraulic pressure through the bottleneck structure.

According to an embodiment, the printing device 300 may include the printing head 340 configured to eject ink, wherein the printing head 340 may include a chamber storing ink, and a spray assembly disposed below the chamber including an ink transfer path extending to inside of the chamber, and externally ejecting the ink that has passed the ink transfer path through a bottom surface.

According to an embodiment, the spray assembly may further include a piezoelectric element layer disposed below the chamber, and a nozzle plate disposed below the piezoelectric element layer and having a bottom surface being the bottom surface of the spray assembly.

Hereinafter, a printing method according to an embodiment will be described in detail based on the above descriptions.

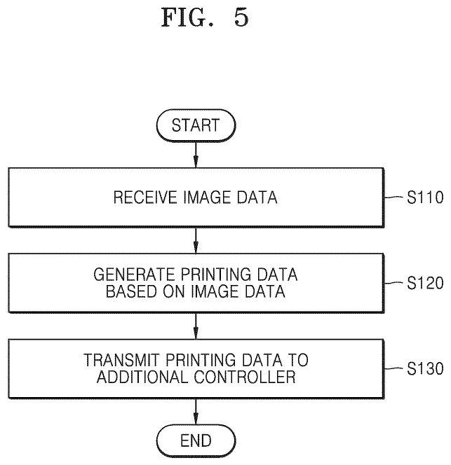

FIG. 5 is a flowchart of processes performed by the controller 100 of FIG. 1. For reference, while describing FIG. 5, details that may be the same as or overlap those of FIGS. 1 to 4 may be omitted.

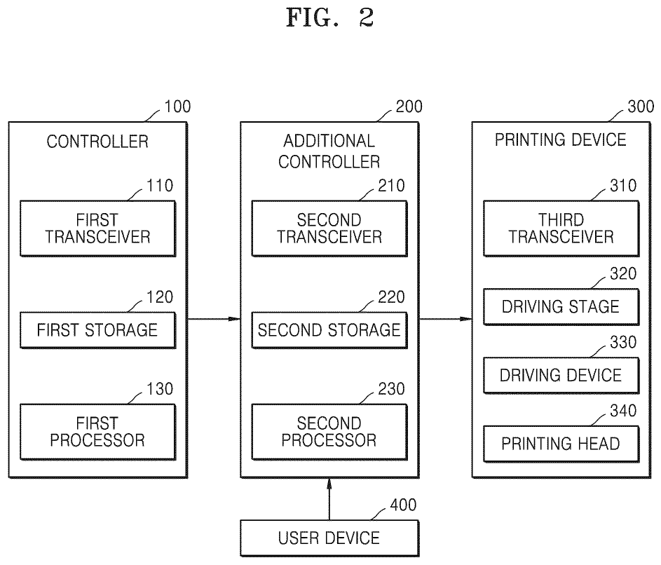

As shown in FIG. 5, the controller 100 of FIG. 1 or the first processor 130 of FIG. 2 may receive image data from an external device (not shown) such as the user device 400 in operation S110. The image data may be image data of a design drawing including a pattern to be printed on the substrate SB. The image data may be stored in the first storage 120.

As shown in FIG. 5, the controller 100 of FIG. 1 or the first processor 130 of FIG. 2 may generate printing data based on the image data in operation S120. The printing data may include location data and volume data as described above. In some cases, the printing data may further include trigger data for starting a process of the additional controller 200. The controller 100 of FIG. 1 or the first processor 130 of FIG. 2 may transmit the generated printing data to the additional controller 200 in operation S130.

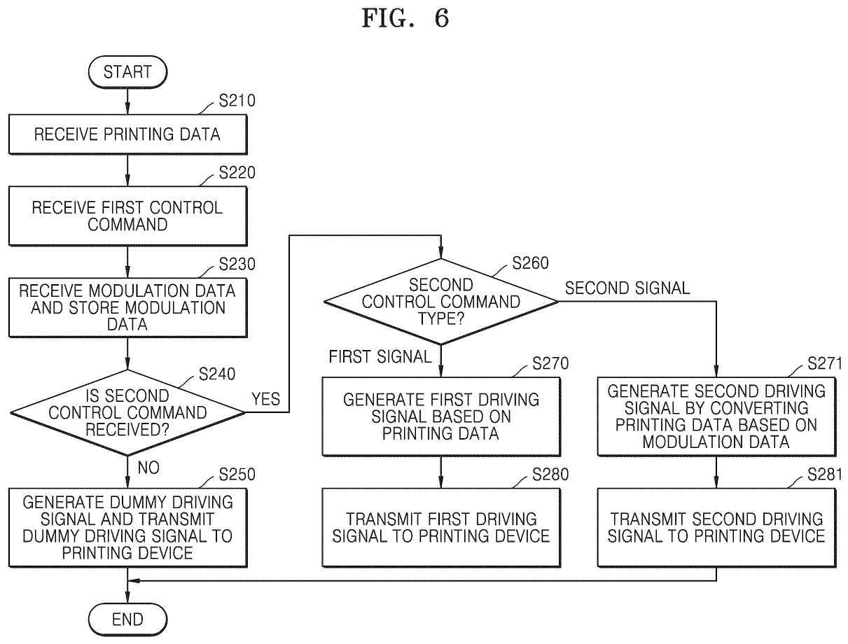

FIG. 6 is a flowchart of processes performed by the additional controller 200 of FIG. 1. For reference while describing FIG. 6, details that are the same as or overlap those of FIGS. 1 to 5 may be omitted, and a subject that performs following processes may be the additional controller 200 or the second processor 230 of the additional controller 200.

As shown in FIG. 6, the printing method according to an embodiment may include receiving printing data from the controller 100 in operation S210, receiving a first control command in operation S220, and receiving and storing modulation data in operation S230.

Operation S210 may be receiving the printing data from the controller 100 through the second transceiver 210. The printing data may denote data obtained by converting an input image to a pre-set format to drive the printing device 300 as described above.

Operation S220 may be receiving the first control command from the user device 400 through the second transceiver 210. For example, the first control command may be command data and include an instruction in a binary format. For example, the first control command may be (0,1) or (1,0).

Operation S230 may be receiving the modulation data from the user device 400 after the first control command is received, and storing the received modulation data in the second storage 220 included in the additional controller 200. For example, the receiving and storing of the modulation data may be receiving of the modulation data from the user device 400 and storing of the same based on the first control command.

As shown in FIG. 6, the additional controller 200 may detect whether a second control command is received from the user device 400 for a pre-set time. For example, the additional controller 200 may obtain information about whether the second control command is received from the user device 400 for a pre-set time in operation S240. In other words, the printing method according to an embodiment may further include receiving the second control command and generating a driving signal based on the received second control command. The second control command may be a first signal or a second signal, and the driving signal may be a dummy driving signal, a first driving signal, or a second driving signal.

In case that the additional controller 200 did not receive the second control command, the additional controller 200 may generate the dummy driving signal and transmit the generated dummy driving signal to the printing device 300.

For example, the printing method according to an embodiment may further include, in case that the second control command is not received, generating the dummy driving signal and transmitting the generated dummy driving signal to the printing device 300 in operation S250. Even in case that the dummy driving signal is transmitted to the printing device 300, the printing device 300 may not perform a printing operation. In other words, in case that the second control command is not received for the pre-set time, the driving signal may be the dummy driving signal.

In case that the additional controller 200 receives the first signal as the second control command in operation S260, the additional controller 200 may generate the first driving signal based on the printing data in operation S270.

For example, the printing method according to an embodiment may include generating the first driving signal based on the printing data in operation S270, and transmitting the generated first driving signal to the printing device 300 in operation S280. The first driving signal may be a signal waveform including information the same as that included in the printing data as described above. In other words, in case that the additional controller 200 receives the second control command during the pre-set time and the second control command is the first signal, the driving signal may be the first driving signal including the same information as the printing data.

In case that the additional controller 200 receives the second signal as the second control command in operation S260, the additional controller 200 may generate the second driving signal by converting the printing data based on the modulation data in operation S271.

For example, the printing method according to an embodiment may include generating the second driving signal by converting the printing data based on the modulation data in operation S271, and transmitting the generated second driving signal to the printing device 300 in operation S281. In other words, in case that the additional controller 200 receives the second control command during the pre-set time and the second control command is the second signal, the driving signal may be the second driving signal including a piece of waveform information from among multiple pieces of pre-stored waveform information loaded from the memory and based on the modulation data.

For example, as described above, the printing data may include location data about locations where ink may be ejected from the printing device 300, and volume data about an amount of ink volume that may be ejected from each nozzle included in the printing device 300.

The modulation data may be data including address information where pieces of data stored in the memory may be assigned. For example, there may be first printing data for printing a line, and the modulation data may include first modulation data that may be address information of the memory where waveform information corresponding to the first printing data may be assigned. As such, the printing data may be converted into pre-stored data or waveform signal based on the modulation data. The second driving signal may be generated based on a waveform signal generated as a result of converting the printing data based on the modulation data. In other words, the second driving signal may include a waveform signal obtained by changing the location data and the volume data based on the modulation data.

For example, the first control command, the second control command, and the modulation data may be implemented as digital signals, and the second control command may be generated based on a user input that may be input to the user device 400.

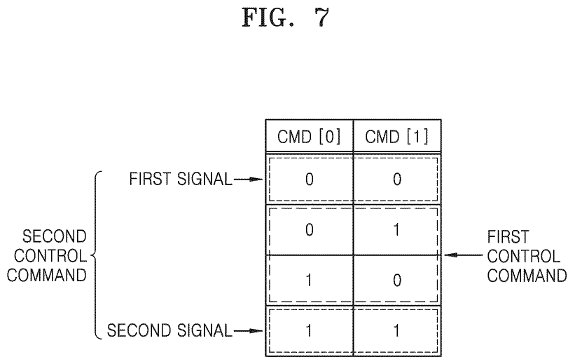

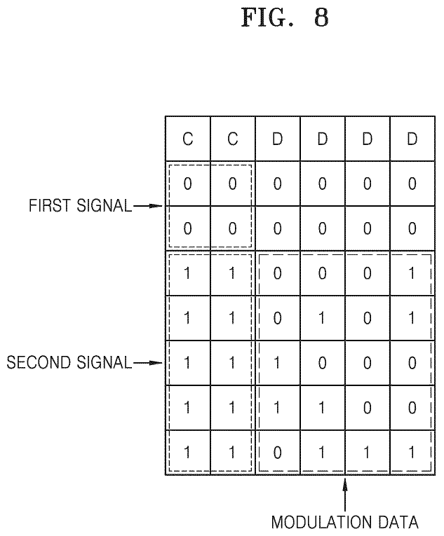

FIG. 7 is a schematic diagram showing examples of the first control command and the second control command, which may be implemented as binary numbers, and FIG. 8 may be a schematic diagram showing examples of the first signal, the second signal, and the modulation data, which may be implemented as binary numbers.

For reference, while describing FIGS. 7 and 8, details that are the same as or overlap those above may be omitted.

As shown in FIG. 7, the first control command may be an instruction for the additional controller 200 to receive and store the modulation data. For example, the first control command implemented as a binary number may be (0 1) or (1 0). The first control command may be an instruction for generating data pre-learned through a learning algorithm.

The second control command may include the first signal and the second signal. For example, the first signal implemented as a binary number may be (0 0), and the second signal implemented as a binary number may be (1 1). For example, in case that (0 0) is input, the first driving signal may be generated and transmitted to the printing device 300. For example, in case that (1 1) is input, the second driving signal may be generated and transmitted to the printing device 300.

As shown in FIG. 8, in case that (0 0) corresponding to the first signal is input, the modulation data may not be input. As a result, in case that (0 0) corresponding to the first signal is input, the first driving signal including the same information as the printing data may be generated and transmitted to the printing device 300.

In case that (1 1) corresponding to the second signal is input, the modulation data may also be implemented as a binary number and include address information assigned to the memory. For example, the modulation data may be implemented as a binary number of 2 digits. As a result, the modulation data may indicate total 2 to 4th power, i.e., 16 pieces of address information. According to the address information indicated by the modulation data, the additional controller 200 may call from the memory waveform information that may replace a printing image.

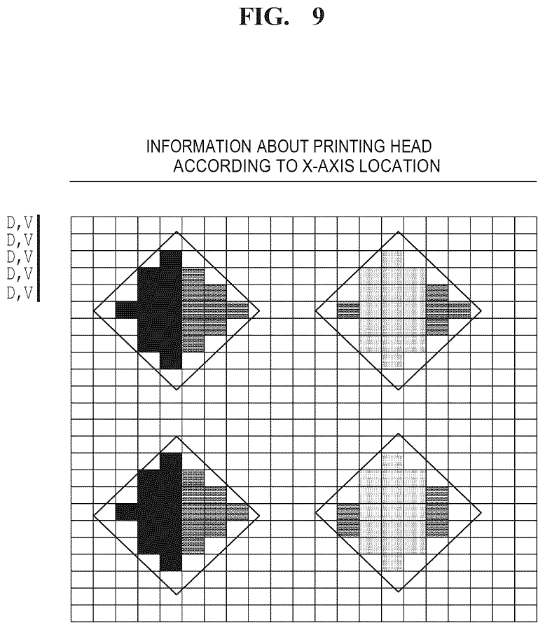

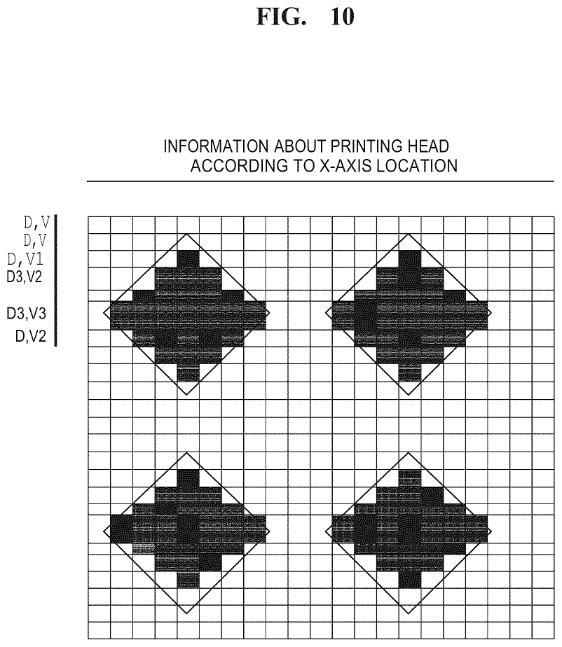

FIG. 9 is a schematic diagram showing a result of performing a printing operation by using a printing system and a printing method according to a comparative example, and FIG. 10 is a schematic diagram showing a result of performing a printing operation by using a printing system and a printing method according to an embodiment.

For reference, while describing FIGS. 9 and 10, details that may be the same as or may overlap those above may be omitted.

As shown in FIG. 9, it may be identified that a relatively non-uniform pattern may be printed as the result of performing the printing operation. It may be identified that (D, V) that corresponding to location data and volume data, respectively have been set to have same values for each nozzle. Accordingly, more printing spots may be identified in the result of FIG. 9 than in the result of FIG. 10, and thus, precision of a printing process may be low in the result of FIG. 9.

As shown in FIG. 10, it may be identified that a relatively uniform pattern may be printed as the result of performing the printing operation. It may be identified that (D, V) that corresponding to location data and volume data, have been set to (D, V1), (D3, V2), (D3, V3), or (D, V2), which may be changed as needed, instead of being set to have the same values for each nozzle. Accordingly, it may be identified that ink has been applied to a more uniform thickness in the result of FIG. 10 than in the result of FIG. 9, and thus a printing process with high precision has been performed in the result of FIG. 10.

For reference, (D, V1), (D3, V2), (D3, V3), and (D, V2), which may be changed as needed, may be pieces of data pre-obtained through results of performing existing printing processes, and may be pieces of data pre-stored in a user device or the like. The pieces of data, such as (D, V1), (D3, V2), (D3, V3), and (D, V2), which may be changed as needed, may be big data automatically obtained by artificial intelligence, a learning algorithm, or the like. The pieces of data, such as (D, V1), (D3, V2), (D3, V3), and (D, V2), which may be changed as needed, may be pieces of data input (e.g., directly input) by a user and stored in the user device or the like.

According to an embodiment described above, a printing system and a printing method, in which precision of a printing process is enhanced, may be realized. Obviously, the scope of the disclosure may not be limited by such effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A printing system comprising:
a controller configured to generate printing data;
a user device configured to generate a first control command, generate modulation data based on a user input, and generate a second control command based on the user input;
an additional controller configured to receive the printing data and the second control command and generate a driving signal based on the second control command, and including a memory storing waveform information received from the user device; and
a printing device configured to perform a printing operation based on the driving signal.

2. The printing system of claim 1, wherein in case that the second control command is a first signal, the driving signal is a first driving signal including same information as the printing data.

3. The printing system of claim 1, wherein in case that the second control command is a second signal, the driving signal is a second driving signal including a piece of waveform information loaded from the memory based on the modulation data from among a plurality of pieces of pre-stored waveform information.

4. The printing system of claim 1, wherein the printing data comprises:
location data about locations where ink is ejected from the printing device; and
volume data about ink volume ejected from each nozzle included in the printing device.

5. The printing system of claim 4, wherein the modulation data comprises address information about where a plurality of pieces of waveform information are stored in the memory.

6. The printing system of claim 5, wherein in case that the second control command is a second signal, the driving signal is a second driving signal including waveform information assigned to the address information in the memory.

7. The printing system of claim 1, wherein the printing device comprises a printing head configured to eject ink,
wherein the printing head comprises:
a chamber storing ink; and
a spray assembly disposed below the chamber, the spray assembly including an ink transfer path extending to inside of the chamber, and the spray assembly externally ejecting the ink from a bottom surface that has passed through the ink transfer path.

8. The printing system of claim 7, wherein the spray assembly further comprises:
a piezoelectric element layer disposed below the chamber; and
a nozzle plate disposed below the piezoelectric element layer and having a bottom surface being the bottom surface of the spray assembly.

9. The printing system of claim 1, wherein the first control command, the second control command, and the modulation data are implemented as digital signals.

10. The printing system of claim 1, wherein the second control command is generated based on a user input that is input to the user device.

11. A printing method comprising:
receiving printing data from a controller;
receiving a first control command from a user device;
receiving modulation data from the user device and storing the modulation data based on the first control command;
receiving a second control command from the user device;
generating a driving signal based on the second control command; and
transmitting the driving signal to a printing device.

12. The printing method of claim 11, wherein, in case that the second control command is not received for a pre-set time, the driving signal is a dummy driving signal.

13. The printing method of claim 11, wherein, in case that the second control command is received for a pre-set time and the second control command is a first signal, the driving signal is a first driving signal including same information as the printing data.

14. The printing method of claim 11, wherein in case that the second control command is received for a pre-set time and the second control command is a second signal, the driving signal is a second driving signal including a piece of waveform information from among a plurality of pieces of pre-stored waveform information, the piece of waveform information is loaded from a memory and is based on the modulation data.

15. The printing method of claim 14, wherein the printing data comprises:
location data about locations where ink is ejected from the printing device; and
volume data about ink volume ejected from each nozzle included in the printing device.

16. The printing method of claim 15, wherein the second driving signal comprises:
a waveform signal obtained by changing the location data; and
the volume data based on the modulation data.

17. The printing method of claim 11, wherein the first control command, the second control command, and the modulation data are implemented as digital signals.

18. The printing method of claim 11, wherein the second control command is generated based on a user input that is input to the user device.

19. The printing system of claim 1, wherein
the printing system is an additive printing technology, and
the second control command being derived from a learning algorithm based on a plurality of earlier printing results.

20. The printing method of claim 11, wherein the second control command is derived from artificial intelligence based on a plurality of earlier printing results.
